(19) United States
(12) Patent Application Publication
(10) Pub. No.: US 2004/0213609 A1
(43) Pub. Date: Oct. 28, 2004

(54) Second cassette feeder control apparatus and method for image forming device

(76) Inventor: Sung-Tack Byun, Suwon-city (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/737,992

(22) Filed: Dec. 18, 2003

(30) Foreign Application Priority Data
Apr. 25, 2003 (KR) 2003-26271

(51) Int. Cl. G03G 15/00

(52) U.S. Cl. 399/391

(57) ABSTRACT

Apparatus and method are provided for controlling a second cassette feeder (SCF) in an image forming device. The control apparatus comprises a main body; a SCF mounted in the main body for supplying sheets of paper; a control unit in the main body for controlling the image forming device; and a SCF control unit for communicating a state of the SCF to the control unit and controlling the SCF. The control method comprises steps of initializing the main body and SCF; deciding whether the SCF is mounted; sending SCF-driving data to the SCF from the main body control unit if the SCF is mounted; and controlling the SCF by the SCF control unit using the driving data. SCFs are therefore compatible since the control unit in the main body downloads driving-related data into the SCF when the SCF is detected, while the SCF programmable ROM and firmware are shared.

### CROSS-REFERENCE TO RELATED APPLICATION

This application claims the benefit of Korean Patent Application No. 2003-26271, filed on Apr. 25, 2003, in the Korean Intellectual Property Office, the disclosure of which is incorporated herein by reference.

### BACKGROUND OF THE INVENTION

1. Field of the Invention

The present invention relates to an apparatus and a method for controlling a second cassette feeder provided for loading more sheets of paper to be fed in electrophotographic image forming devices such as photocopiers, laser printers, facsimile machines, and so on, for photocopying and printing in use of plain print sheets.

2. Description of the Related Art

FIG. 1 shows a printer as one of the electrophotographic image forming devices, which is used in general. If a user presses a print button, a photoconductive drum 50 is uniformly charged by the corona discharge of a charging unit 42, and, in a laser beam printer (LBP), as the photoconductive drum 50 rotates, the charged portions are exposed through the exposure unit 41 with mirrors and lenses to light emitted from a light source such as a light emission diode or a laser diode and reflected from a document. In a photocopier, after processing based on a contraction/magnification factor and so on by four mirrors and lenses, the same electrostatic latent image that is an image on the document is formed on the photoconductive drum 50. At this time, the formed electrostatic latent image is developed into a visible image with toner during passing through a developing unit 44, and the visible image of the photoconductive drum 50 is transferred by the operations of a transfer unit 48 on a sheet of paper 46 fed by a feeding roller 45. At this time, the sheet of paper 46 comes in close contact with the photoconductive drum 50 by an electrostatic force, and a separator 49 separates the closely contacted sheet of paper. Thereafter, as the separated sheet 46 passes through a heating roller 51 and a press roller 52, the document image is fixed and printed as desired on the sheet 46 by heat and pressure.

In the meantime, there exists the residual toner and latent image on the surface of the photoconductive drum 50 passing through the transfer unit 48. The toner is removed by a cleaner (not shown) and the latent image is eliminated by a pre-erase lamp array 43.

The printer operating as above has the cassette feeder 55 capable of loading 150 to 250 sheets, and may optionally have a second cassette feeder (SCF) 55a driven by a separate driving mechanism for more sheets of paper to be fed as shown in FIG. 1. Such an SCF 55a is generally installed under a main cassette feeder 55 for the supply of sheets 46a. At this time, the sheets 46a are not transferred to a paper feeding roller 39 of the main body of the printer by a pickup motor 45a alone for sheet supply, so relay rollers 56 are mounted over the upper part of the SCF 55a. Further, a roller-opening unit (not shown) such as a spring or the like is generally formed to split the relay rollers 56 against paper jams between the relay rollers 56.

A schematic control block diagram for the printer as above is shown in FIG. 2. In FIG. 2, a control unit 60 controls the applications of predetermined voltages to the charging unit 42, developing unit 44, and transfer unit 48, and also controls the overall printer system to print image data or images on sheets, while checking operation states through various sensors (not shown). The SCF 55a has a SCF control unit 70, a motor drive 71 and a programmable ROM 72. The programmable ROM 72 stores programs necessary for the system initialization, programs necessary for communication protocols, and data necessary for driving the SCF such as an acceleration table and the like necessary for driving motors. The SCF control unit 70 generally receives data as electrical signals through a communication cable 80 from the control unit 60, interprets the data, and executes corresponding commands. That is, the SCF control unit 70 picks up sheets of paper, drives and stops the pickup motor 45a, and drives and stops the relay rollers 56 as its main operations, as well as recognizes paper sizes and sends to the control unit 60 signals notifying of ‘paper empty’, ‘tray out’, and so on. In particular, the SCF control unit 70 controls a motor drive IC 71 to drive motors in accordance with the acceleration table stored in the programmable ROM 72.

A brief description will now be made about the operations of the SCF for a printer having the SCF structured as above. In generally, the printer waits for a command from the control unit 60. The SCF 55a on which the sheets 46a are loaded is completely inserted in the frame (not shown). If a paper-feeding request signal is received through the cable 80, the SCF control unit 70 controls the motor drive IC 71 to rotate the pickup motor 45a in accordance with the acceleration table stored in the programmable ROM 72 so that the sheets 46a are fed from the SCF 55a at a certain speed continuously to the paper feeding roller 39 of the main body according to the rotations of the relay roller 56. The subsequent operations are to carry out usual print jobs based on the controls of the main control unit 60.

However, the printer having the SCF structured as above has a problem in that it uses a programmable ROM dedicated to each SCF. In other words, all SCF-related driving data is stored in the programmable ROM for the corresponding SCF. Thus, the programmable ROMs cannot be shared with one another since the programmable ROM specifications for individual SCFs are different from one another. For example, the motor speeds for SCFs are decided based on paper discharge speeds. Since the all the paper discharge speeds are different, the printer cannot use, for the SCF mounted, a programmable ROM 72 storing the motor-drive acceleration data that is for a different printer model. That is, a motor speed is determined based on a pulse frequency inputted to a motor. Accordingly, a predetermined frequency value should be inputted for a DC motor, and an acceleration table is used for a stepping motor. The acceleration data should be continuously changed for a stepping motor used as a general printer motor, and the data is stored in the programmable ROM 72 for the SCF in the form of a table (refer to Table 1 in the disclosure). Since the motor speeds are stored for use in respective programmable ROMs in the form of a table even through the operations of the SCF are basically the same, the programmable ROM for the SCF cannot be shared. Further, there exists a problem in that the SCF is newly classified for use all the time, even in case of the same mechanical specifications and hardware.

### SUMMARY OF THE INVENTION

In order to solve the above problems, it is an aspect of the present invention to provide a second cassette feeder control apparatus and method capable of controlling a second cassette feeder in the same manner as usual and sharing a programmable ROM and firmware for the second cassette feeder by downloading to the second cassette feeder data related to the driving of the second cassette feeder when a control unit of an image forming device detects the installation of the second cassette feeder.

In order to achieve the above aspect, a second cassette feeder control apparatus for an image forming device according to the present invention comprises a main body of the image forming device; at least one second cassette feeder (SCF) mounted in the main body, and for auxiliarily supplying sheets of paper; a control unit installed in the main body, and for controlling a printer system of the image forming device; communication cables for connecting the control unit and the second cassette feeder for communications therebetween; a connection line for connecting the control unit and the second cassette feeder; and at least one SCF control unit provided in correspondence to the second cassette feeder, and for receiving SCF-driving data from the control unit and controlling operations of the second cassette feeder.

Moreover, the apparatus further comprises a connection detecting unit for detecting a signal inputted through the connection line and deciding a connection state of the second cassette feeder, wherein the control unit sends the SCF-driving data to the SCF control unit through the communication cables if the connection detecting unit detects the connection of the second cassette feeder or electric power is supplied.

The second cassette feeder further includes a programmable ROM for storing system initialization and communication-related programs; and a RAM for storing the SCF-driving data sent from the control unit.

Preferably, the SCF-driving data is motor-driving data.

Further, the SCF control unit controls a motor in use of the motor-driving data stored in the RAM if a motor-driving command is received from the control unit.

Preferably, if plural second cassette feeders are detected, the control unit sequentially sends data to respective SCF control units or first sends the data to a specified SCF control unit out of the plural SCF control units before the remaining SCF control units receives the sent data from the specified SCF control unit.

The control unit further includes at least one or more sensors for deciding a state of the second cassette feeder, and a multiplexer for inputted outputs of the sensors, wherein the SCF control unit converts the output of the multiplexer into data and sends the data to the control unit.

In order to achieve the above object, a second cassette feeder control method for an image forming device having a second cassette feeder (SCF) mounted in a main body of the device for more sheets of paper to be fed, a main body control unit, and an SCF control unit, comprises steps of initializing the main body and the second cassette feeder if electric power is supplied; deciding by the main body control unit whether the second cassette feeder is mounted; sending SCF-driving data to the second cassette feeder through communication cables by the main body control unit if it is decided that the second cassette feeder is mounted in the step of deciding the mounting of the second cassette feeder; and controlling the second cassette feeder by the SCF control unit in use of the sent SCF-driving data.

Further, the step of deciding the mounting of the second cassette feeder is carried out through a connection detecting line connecting the main body and the second cassette feeder.

The step of initializing the second cassette feeder initializes the second cassette feeder in use of data stored in a programmable ROM of the second cassette feeder (SCF).

Preferably, the SCF control unit further stores the sent SCF-driving data in a RAM.

Further, it is preferable that the SCF-driving data is motor-driving data.

In order to achieve the above object, another second cassette feeder control method comprises steps of deciding by the main body control unit whether the second cassette feeder is mounted; sending SCF-driving data to the second cassette feeder by the main body control unit if it is decided that the second cassette feeder is mounted in the step of deciding the mounting of the second cassette feeder; and storing the sent driving data in a RAM by the SCF control unit.

### BRIEF DESCRIPTION OF THE DRAWINGS

The invention will be described in detail with reference to the following drawings in which like reference numerals refer to like elements, and wherein:

FIG. 1 is a side view for showing a printer in which a conventional second cassette feeder is mounted;

FIG. 2 is a control block diagram for a conventional printer;

FIG. 3 is a control block diagram for a printer according to an embodiment of the present invention;

FIG. 4 is a flow chart for showing a process for data transfer flows according to an embodiment of the present invention; and

FIG. 5 is a flow chart for showing a process for controlling a motor speed according to an embodiment of the present invention.

### DETAILED DESCRIPTION OF THE PREFERRED EMBODIMENTS

Hereinafter, descriptions will be made in detail on a printer, although other types of image forming devices can be used, having a second cassette feeder according to an embodiment of the present invention with reference to the attached drawings.

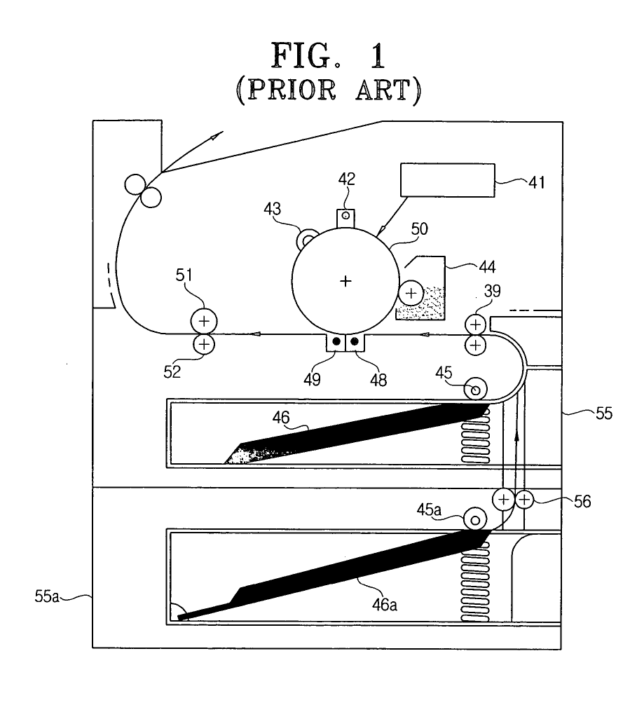

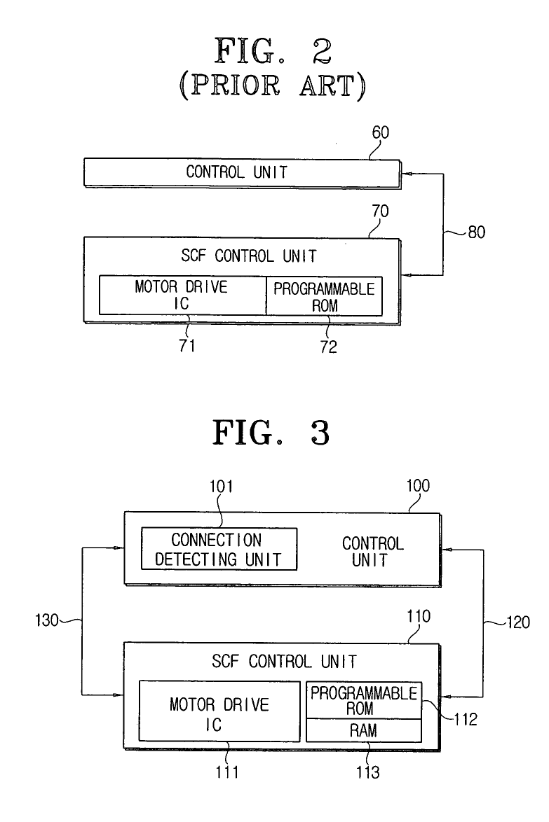

FIG. 3 is a control block diagram for a printer according to an embodiment of the present invention. Further, like reference numerals are employed to the like elements shown in the perspective view of FIG. 1 for the printer having the second cassette feeder mounted, and the descriptions of which will be omitted.

A control unit 100 controls the applications of voltages to the charging unit 42, developing unit 44, and the transfer unit 48, controls printing on a sheet image data or an image corresponding to image data to be printed, and controls operation states through various sensors (not shown). The control unit 100 receives and sends general data with the SCF 55a in use of a data communication cable 120, and reads the states of the SCF 55a, and transfers data for driving the SCF 55a if necessary. In particular, the control unit 100 can send data for motor controls. That is, the control unit 100 transfers initial and final values, a slope, and the number of steps from the stepping motor acceleration table of Table 1. A connection detecting unit 101 is constructed to detect (e.g., substantially continually or periodically) a mounted or a dismounted state of the SCF 55a, that is, whether the SCF 55a is mounted or dismounted, through a connection detecting line 130. If the control unit 100 sends a state request signal SCF_CMD_RQST_STATE; 0xff to a SCF control unit 110 and any data is not sent from the SCF 55a (data to be actually sent is 0x00), the control unit 100 decides the SCF 55a is disconnected, and, if the printer normally operates, the control unit 100 can send data notifying of the mounted or dismounted state of the SCF 55a, paper size, and ‘paper empty’. Preferably, the control unit 100 inputs the outputs of the sensors via a three-input multiplexer, and uses one bit of data to be sent to indicate the mounted or dismounted state of the SCF 55a, three bits of the same data to indicate a paper size, and one bit of the same data to indicate the ‘paper empty’, when sending a state signal.

The SCF control unit 110 has a motor drive IC 111, a programmable ROM 112, and a RAM 113. The programmable ROM 112 stores programs necessary for system initializations and programs necessary for communication protocols, and the RAM 113 stores data for driving the SCF which is transferred through a communication cable 120 from the control unit 100. In more detail, the programmable ROM 112 receives from the control unit 100 and stores in the RAM 112 data regarding paper pickups, paper size recognitions, and ‘paper empty’ and ‘tray out’ signals, among others, that are the main operations of the SCF. If necessary, the SCF control unit 110 reads out necessary data from the RAM 112, and processes the data for related operations. In particular, the SCF control unit 110 can store data for driving a motor for the SCF. Accordingly, if the SCF control unit 110 inputs a command for driving the motor from the control unit 100, the SCF control unit 110 controls the motor drive IC 111 to drive the motor (not shown) in use of the data stored in the RAM 112. Further, if the SCF control unit 110 inputs a command as an electric signal through the cable 120 from the control unit 100, the SCF control unit 110 interprets the command and executes related commands. That is, the SCF control unit 110 performs main operations such as paper pickups, paper size recognitions, ‘paper empty’ and ‘tray out’ signaling, and so on.

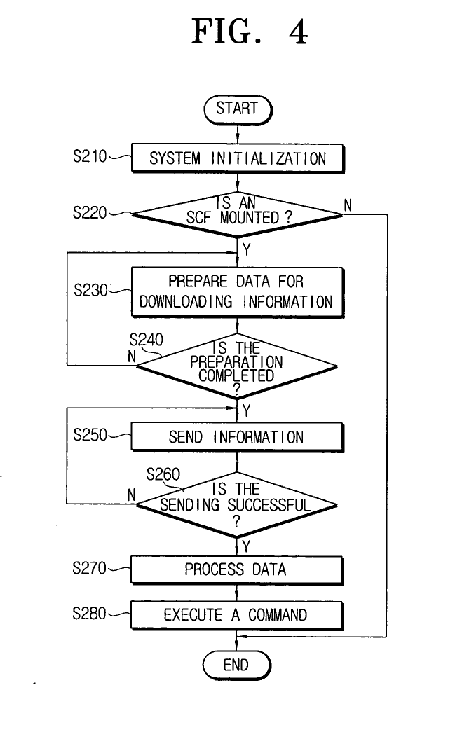

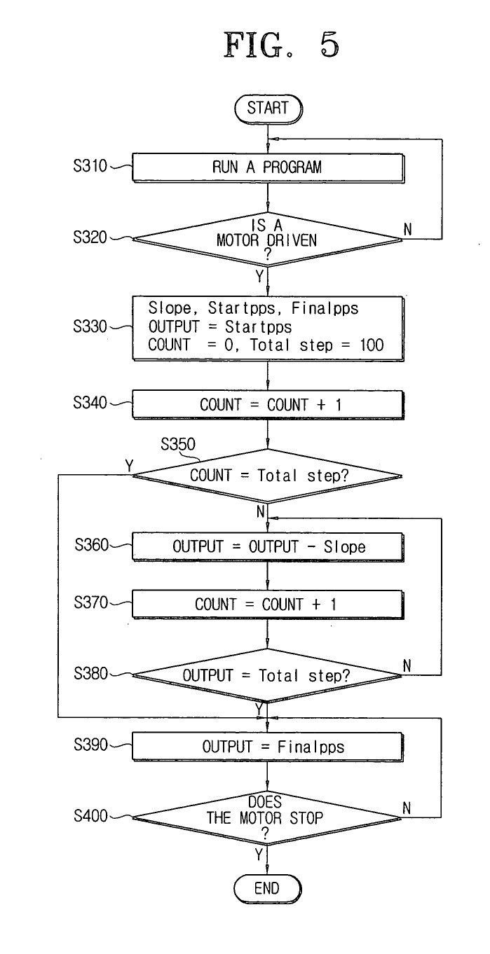

Hereinafter, descriptions will be made on the operations of the second cassette feeder structured as above and the control method therefor with reference to FIG. 4 and FIG. 5. In particular, the descriptions of the present embodiment are restricted to data related to the driving of a motor out of the data for driving the SCF. FIG. 4 is a flow chart for showing a process for controlling a motor speed.

If electric power is applied to a printer system, the control unit 100 and the SCF control unit 110 initialize the system, respectively (Step S210). The connection detecting unit 101 of the control unit 100 decides whether the SCF 55a is mounted through the connection detecting line 130 (Step S220). If it is decided that the SCF 55a is mounted in the step S220, the control unit 100 prepares data related to the driving of a motor, out of SCF-driving data, for a transmission to the control unit 110 (Step S230). For example, information on initial and final values and the number of steps from the stepping motor acceleration table such as Table 1 below is transmitted among the data to be sent.

If the data to be sent is completely prepared (S240), the control unit 100 sends the related data to the SCF control unit 110 (S250). If it is decided that the SCF 55a is not mounted in the step S220, the control unit 100 ends its controls, and, if the data to be sent is not completely prepared in the step S240, the control unit 100 repeats the step S230. The control unit 100 decides whether the data sent according to the predefined communication code is normally transmitted and received (S260). If the data is normally transmitted and received in the step S260, the SCF control unit 110 stores the received motor-related data in the RAM 113 (S270). If transmission errors occur in the step S260, the control unit 100 repeats the step S250 till the transmissions are successfully completed.

It is to be understood, for the second cassette feeder control method described herein, that electric power is initially applied, and that electric power is applied and the system is initialized in the same manner even when the SCF 55a in which the sheets 46a are loaded is inserted to be mounted in the frame (not shown).

Hereinafter, a motor control method using a motor-driving acceleration table will be described with reference to FIG. 5.

An exemplary stepping motor acceleration table provided by the control unit 100 is illustrated in Table 1.

TABLE 1

| Steps | Control Values |
|---|---|
| 1^{st}(initial value) | 10000 |
| 2^{nd} | 9910 |
| 3^{rd} | 9820 |
| . | . |
| . | . |
| 100^{th}(final value) | 1000 |

The control values are gradually changed in order to accelerate a stepping motor, and the above Table 1 shows that the number of steps for controlling the stepping motor is set to “100”, an initial value to “10000”, and a final value to “1000”. Accordingly, for the following description, it is to be understood that the control unit 100 sends the initial and final values and the number of steps to the SCF control unit 110.

The SCF control unit 110 decides whether it drives the pickup motor 45a (S320) while running a general program according to a command received from the control unit 100 (S 310). The SCF control unit 110 reads out data such as initial and final values and the number of steps stored in the RAM 113 if it is necessary to drive a motor, and calculates slopes each of which is an increment or a decrement value by step. Accordingly, the SCF control unit 110 sets a value “startpps” to a final pulse width output value “OUTPUT” for controlling the motor. Further, the SCF control unit 110 inputs “0” to a value “COUNT” for counting the steps (S330). In more detail, the value “startpps” is set to “10000”, a value “finalpps” to “1000”, and a slope value “slope” to “90”. That is, the slope is calculated when the interval between the initial value and the final value is divided by the number of entire steps.

Slope=(initial value−final value)/the number of steps Equation 1

The slope of “90” is obtained from the Equation 1 when related values are applied with reference to Table 1. However, the SCF control unit 110 outputs to the motor drive IC 111 a driving signal, which is a “HIGH” signal in general, for initially driving the control of the motor to drive the motor and, at the same time, starts decrementing “10000” inputted as a value “OUTPUT” via an internal clock (not shown). If the decrementing is completed to a value of “0”, the SCF control unit 110 turns the driving signal into “LOW” for an output.

If it is decided that the motor driving signal is turned into “LOW” in the above step, the SCF control unit 110 increases the value “COUNT” by 1(S340), and decides whether the value “COUNT” is “100” which is the number of total steps. If decided as the final step in the step, the SCF control unit 110 assigns “1000” to the final value “finalpps” for the value “OUTPUT”, and discounts via the internal clock (not shown) to apply a constant motor driving pulse. That is, the SCF control unit 110 decides whether to stop the motor in the step S400, and controls a constant driving pulse output by stopping the motor if there is an occasion that the motor has to stop, and repeating the steps S390 and S400 to output a constant driving pulse if there is not an occasion that the motor has to stop. The stable driving of the motor after all is not controlled with a control value in the last step that is obtained from decreasing a slope value prior to the last step, but controlled with the value “finalpps” corresponding to the predetermined final value. Thus, the present invention consistently controls the motor at a substantially constant speed in order for the constant number of sheets to be discharged per minute.

Further, in case that the number of sheets to be discharged per minute increases with the printer performance improved, it is required that only the values of the acceleration table are modified and transmitted, so that it is convenient since there is no need to replace the programmable ROM 112 as in the Prior Art.

If the step S350 is not the last step, the SCF control unit 110 subtracts the slope value from the value “OUTPUT” and drives the motor in the same way as above (S360), and increases the value “COUNT” by 1 again (S370). Thereafter, the SCF control unit 110 decides whether the step is the last step (S380), and, if it is decided that the step is not the last step, the SCF control unit 110 repeats the step S360.

If it is decided that the step S380 is the last step, the SCF control unit 110 sets “1000” to the value “OUTPUT”, and decrements via the internal clock (not shown) to apply a constant motor driving pulse. That is, the SCF control unit 110 decides whether the motor stops in the step S400, and controls the motor to drive at a constant speed by stopping the motor if there is an occasion that the motor has to stop, and repeating the steps S390 and S400 to output a constant driving pulse if there is not an occasion that the motor has to stop

The above description of the present invention employed a structure whereby the SCF control unit has a programmable ROM in which basic programs necessary for system initializations and communication protocols are stored and a RAM in which data such as an acceleration table transmitted from the control unit is stored. The present invention, however, can be implemented using one RAM such as a non-volatile memory (NVRAM). That is, the SCF control unit uses, upon system initializations, the basic programs necessary for the system initializations and communication protocols that are stored in the NVRAM, and can receive from the control unit and use the data related to the driving of the SCF.

Further, the above descriptions of the present invention employed one SCF mounted therein, but the present invention can control an apparatus having plural SCFs in the manner that the control unit sequentially sends data to the respective SCF control units, or first sends related data to a specified SCF control unit out of the plural SCF control units and the remaining SCF control units receive the sent related data from the specified SCF control unit.

As described above, the second cassette feeder control apparatus and method according to the present invention enables all SCFs to be compatibly used since the control unit of the main body can download driving-related data into the second cassette feeder and control the second cassette feeder in the same manner as in the prior art if the control unit detects that the second cassette feeder is mounted, and, at the same time, the programmable ROM and the firmware for the SCF can be shared.

Although the preferred embodiments of the present invention have been described, it will be understood by those skilled in the art that the present invention should not be limited to the described preferred embodiments, but various changes and modifications can be made within the spirit and scope of the present invention as defined by the appended claims.

What is claimed is:

1. A second cassette feeder control apparatus for an image forming device, comprising:
a main body of the image forming device;
at least one second cassette feeder (SCF) mounted in the main body, and for auxiliarily supplying sheets of paper;
a control unit installed in the main body, and for controlling a printer system of the image forming device;
a connection line for connecting the control unit and the second cassette feeder; and
at least one SCF control unit provided in correspondence to the second cassette feeder, and for receiving SCF-driving data from the control unit and controlling operations of the second cassette feeder.

2. The apparatus as claimed in claim 1, further comprising a connection detecting unit for detecting a signal inputted through the connection line and deciding a connection state of the second cassette feeder; and communication cables for connecting the control unit and the second cassette feeder for communications therebetween;
wherein the control unit sends the SCF-driving data to the SCF control unit through the communication cables if the connection detecting unit detects the connection of the second cassette feeder or electric power is supplied.

3. The apparatus as claimed in claim 1, wherein the second cassette feeder (SCF) further includes:
a programmable ROM for storing system initialization and communication-related programs; and
a RAM for storing the SCF-driving data sent from the control unit.

4. The apparatus as claimed in claim 3, wherein the SCF-driving data is motor-driving data.

5. The apparatus as claimed in claim 4, wherein the SCF control unit controls a motor using the motor-driving data stored in the RAM if a motor-driving command is received from the control unit.

6. The apparatus as claimed in claim 1, wherein, if plural second cassette feeders are detected, the control unit sequentially sends data to respective SCF control units, or first sends the data to a specified SCF control unit out of the plural SCF control units before the remaining SCF control units receives the sent data from the specified SCF control unit.

7. The apparatus as claimed in claim 1, wherein the control unit further includes:
at least one sensor for deciding a state of the second cassette feeder; and
a multiplexer for inputing outputs of the sensors, the SCF control unit converting the output of the multiplexer into data and sending the data to the control unit.

8. A second cassette feeder control method for an image forming device having a second cassette feeder (SCF) mounted in a main body of the device for more sheets of paper to be fed, a main body control unit, and an SCF control unit, comprising steps of:
initializing the main body and the second cassette feeder if electric power is supplied;
deciding by the main body control unit whether the second cassette feeder is mounted;
sending SCF-driving data to the second cassette feeder through communication cables by the main body control unit if it is decided that the second cassette feeder is mounted in the step of deciding the mounting of the second cassette feeder; and
controlling the second cassette feeder by the SCF control unit in use of the sent driving data.

9. The method as claimed in claim 8, wherein the step of deciding the mounting of the second cassette feeder is carried out through a connection detecting line connecting the main body and the second cassette feeder.

10. The method as claimed in claim 8, wherein the step of initializing the second cassette feeder initializes the second cassette feeder using data stored in a programmable ROM of the second cassette feeder (SCF).

11. The method as claimed in claim 8, wherein the SCF control unit further stores the sent SCF-driving data in a RAM.

12. The method as claimed in claim 11, wherein the SCF-driving data is motor-driving data.

13. A second cassette feeder control method for an image forming device having a second cassette feeder (SCF) mounted in a lower portion of a main body of the device for more sheets of paper to be fed, a main body control unit, and a SCF control unit, comprising steps of:
deciding by the main body control unit whether the second cassette feeder is mounted;
sending SCF-driving data to the second cassette feeder by the main body control unit if it is decided that the second cassette feeder is mounted in the step of deciding the mounting of the second cassette feeder; and
storing the sent driving data in a RAM by the SCF control unit.

14. The method as claimed in claim 13, wherein the step of deciding the mounting of the second cassette feeder is detected through a connection detecting line connecting the main body and the second cassette feeder.

15. The method as claimed in claim 13, wherein the SCF-driving data is motor-driving data.

16. The method as claimed in claim 15, wherein the SCF control unit controls a motor in use of the motor-driving data stored in the RAM if a motor-driving command is received from the main body control unit.
